(19) United States
(12) Patent Application Publication
(10) Pub. No.: US 2022/0228669 A1
(43) Pub. Date: Jul. 21, 2022

(54) Pump for A System for Applying A Coating Product, and Use of Such A Pump

(71) Applicant: EXEL INDUSTRIES, EPERNAY (FR)

(72) Inventors: Nicolas Plantard, Paris (FR); François Morales, Paris (FR)

(21) Appl. No.: 17/605,210

(22) PCT Filed: May 15, 2020
(86) PCT No.: PCT/EP2020/063591

§ 371 Date: Oct. 20, 2021

(30) Foreign Application Priority Data
May 16, 2019 (FR) FR1905163

(51) Int. Cl. F16K 27/02; F16K 15/04; F04B 53/10; F04B 15/02; F04B 53/22

(52) U.S. Cl. CPC F16K 27/0209; F16K 15/04; F04B 53/1087; B05B 9/0413; F04B 53/1002; F04B 53/22; F04B 15/02

(57) ABSTRACT

A pump including a pump body and an intake valve attached to the pump body, connected to a source of a coating product, the intake valve including a valve body and a valve shutter. The valve body includes a first component secured to the pump body, and a second component screwed to the first component and including a valve-shutter support situated radially toward the inside of the first component and forming a seat of the valve to collaborate with the valve shutter to establish sealing, the second component also including a nut, attached to the valve-shutter support, extending radially around an end part of the first component, this end part having an external screw thread collaborating with an internal screw thread of the nut, and when the nut has been unscrewed from the first component, the second component and the valve shutter may be extracted from the first component.

### CROSS-REFERENCE TO RELATED APPLICATIONS

This application claims benefit under 35 USC § 371 of PCT Application No. PCT/EP2020/063591 entitled PUMP FOR A SYSTEM FOR APPLYING A COATING PRODUCT, AND USE OF SUCH A PUMP, filed on May 15, 2020 by inventors Nicolas Plantard and Francois Morales. PCT Application No. PCT/EP2020/063591 claims priority of French Patent Application No. 19 05163, filed on May 16, 2019.

### FIELD OF THE INVENTION

The present invention relates to a pump for a system for applying a coating product and a use of such a pump.

### BACKGROUND OF THE INVENTION

Pneumatic pumps for systems for applying a coating product, such as paints or varnishes, include an intake valve for the product, through which the product is discharged under high pressure, from a source containing the product and toward an application device. This valve is generally screwed to the pump body and ensures sealing relative to the outside and stopping of the flow of product during shut-down periods of the pump.

The passage of the product in the intake valve involves periodic cleaning. When the product cools, a deposit in skin form may appear, and over time the pump may no longer take up the product.

The valve must then be disassembled in order to clean its component parts, in particular the valve, the seat of the valve shutter, the components that ensure the sealing between the valve and the pump body, etc. These disassembly operations generally require a certain number of tools and quantity of time, whereas the operators who use the pumps do not necessarily have all of the necessary tools at their disposal, or work outdoors under conditions that are not favorable to maintenance.

Furthermore, on some pumps, the screw threads of the valve may be placed in contact with the product, which complicates the disassembly.

The invention aims to address these drawbacks by proposing a new pump for a coating product application system allowing simplified cleaning and maintenance operations.

### SUMMARY OF THE DESCRIPTION

To this end, the invention relates to a pump for a system for applying a coating product, comprising a pump body, and an intake valve secured to the pump body, intended to be connected to a source of coating product, the intake valve comprising a valve body and a valve shutter. This pump is characterized in that the valve body comprises a first component secured to the pump body, and a second component screwed to the first component, said second component including a valve-shutter support, situated radially toward the inside of the first component and forming a seat of the valve which is intended to collaborate with the valve shutter in order to establish sealing, in that the second component also includes a nut, attached to the valve-shutter support, extending radially around an end part of the first component, this end part having an external screw thread cooperating with an internal screw thread of the nut, and in that after unscrewing of the nut from the first component, the second component and the valve shutter can be extracted from the first component.

Owing to the invention, the seat of the valve shutter and the valve shutter can be disassembled easily by unscrewing through the bottom of the pump.

According to advantageous but optional aspects of the invention, such a pump may incorporate one or more of the following features, considered in any technically allowable combination:
The nut is provided with external disassembly shapes making it possible to unscrew or screw the second component in the first component using a nonspecific tool. The seat of the valve shutter and the valve shutter can therefore be disassembled without specific tooling.
The valve-shutter support includes a tubular part supporting the seat, said tubular part being inserted into an internal cavity of the first component. A maximum external diameter of the tubular part of the valve-shutter support and a maximum external diameter of the valve shutter are smaller than a minimum internal diameter of the internal cavity.
The external screw thread is fluidly insulated from the internal cavity by a tubular end part of the first component. The internal screw thread is fluidly insulated from an internal duct of the second component by the tubular part of the valve-shutter support.
The first component comprises a frustoconical internal bearing surface against which a corresponding external frustoconical surface of the valve-shutter support bears so as to create sealing between the valve-shutter support and the first component.
The seat of the valve is formed by a component attached on the valve-shutter support.
The nut and the valve-shutter support are attached so as not to be separable.
The nut is connected inseparably with a tool for unscrewing the second component.
The external shapes of the nut form radial protuberances extending in planes comprising a central axis of the pump, able to be actuated by percussion by a nonspecific tool for the unscrewing or the screwing of the second component.
The external shapes of the nut form a recess for accommodating a nonspecific unscrewing or screwing tool for the second component.

The invention also relates to a use of a pump as mentioned above, characterized in that it consists in using a nonspecific tooling to unscrew or to screw the second component with respect to the first component by action on the external shapes of the nut of the second component using said nonspecific tool.

### BRIEF DESCRIPTION OF THE DRAWINGS

The invention will be better understood, and other advantages thereof will appear more clearly, in light of the following description of a pump and a use of this pump according to its principle, provided as a non-limiting example and in reference to the appended drawings, in which:

FIG. 1 is a sectional view in a longitudinal plane of a pump according to the invention, in a disassembled configuration;

FIG. 2 is a sectional view similar to FIG. 1, in an assembled configuration;

FIG. 3 is a perspective view of the pump of FIG. 1 in the disassembled configuration;

FIG. 4 is a perspective view of the pump in the assembled configuration and during unscrewing of an intake valve of the pump;

FIG. 5 is a perspective view of the pump in the disassembled configuration, showing a variant embodiment of a nut of the intake valve;

FIG. 6 is a perspective view of the pump in the assembled configuration and during unscrewing, showing an unscrewing tool inseparably connected to the intake valve.

### DETAILED DESCRIPTION OF EMBODIMENTS

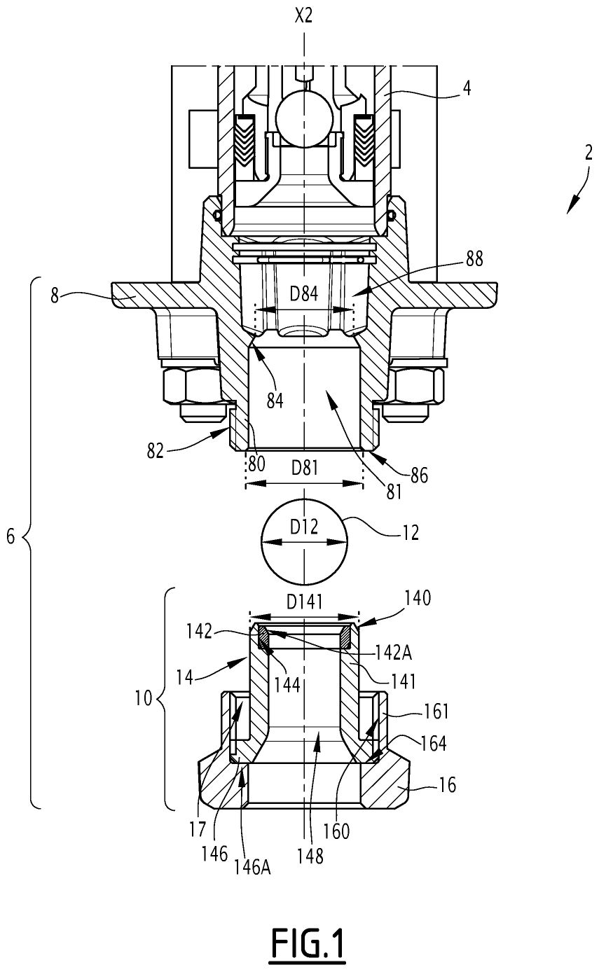

FIG. 1 shows a pump 2 for a system for applying a coating product, for example a paint or a varnish. Such a pump is in particular intended for exterior uses, for example worksites, hulls of boats, coating metal frames, for applying paints or anticorrosion materials. For interior use, such a pump can be used in the automotive industry.

The invention applies to pumps using air as vector for the product to be applied, as well as airless pumps.

The pump 2 comprises a pump body 4, and an intake valve 6 secured to the pump body 4, intended to be connected to a source of covering product, not shown. The intake valve 6 comprising a valve body formed by a first component 8 secured to the pump body 4, and by a second component 10 screwed to the first component 8, and a valve shutter. The valve shutter is formed in this example by a ball 12. The pump 2 defines a longitudinal central axis X2.

The longitudinal axis X2 is a vertical axis, and hereinafter, the directions “top” and “bottom” are used in reference to the longitudinal axis X2 relative to the orientation of FIG. 1. The pump body 4 is therefore located in the top part of the pump 2, while the intake valve 6 is located in the bottom part.

The terms “inner,” “internal,” “outer,” “external,” “radial” or “axial” are used in reference to this axis X2. A radial surface is a curved surface surrounding the central axis X2, and an axial surface is a surface perpendicular to the axis X2.

The first component 8 is attached to the pump body 4 by any suitable means, for example by screwing.

The second component 10 includes a valve-shutter support 14, situated radially inside the first component 8 and forming a seat 142 of the valve 6 which is intended to cooperate with the ball 12 in order to establish sealing between the first component 8 and the second component 10.

The second component 10 can optionally comprise a tube, not shown, for connecting to a product suction tube.

The first component 8 has a globally cylindrical geometry centered on the central axis X2 and defining an internal cavity 81, in which the valve-shutter support 14 is received. The valve-shutter support 14 is globally cylindrical and centered on the central axis X2, and has a tubular part 141 which is received in the internal cavity 81. The tubular part 141 has a maximum external diameter D141 which is smaller than a minimum internal diameter D81 of the internal cavity 81.

The second component 10 also includes a nut 16, attached to the valve-shutter support 14, extending radially around an end part 80 of the first component 8, this end part 80 having an external screw thread 82 cooperating with an internal screw thread 160 of the nut 16. The end part 80 has a tubular shape centered on the central axis X2 and extends downward while surrounding the internal cavity 81. The external screw thread 82 is provided on an external radial surface of the end part 80.

The external screw thread 160 is provided on an internal radial surface of a tubular part 161 of the nut 16, centered on the central axis X2, and which forms an upward extension parallel to the tubular part 14 of the valve-shutter support 14. The tubular parts 141 and 161 define an annular space 17 between them in which the end part 80 of the first component 8 is received.

The first component 8 comprises a frustoconical internal bearing surface 84 against which a corresponding external frustoconical surface 140 of the valve-shutter support 14 bears so as to create sealing between the valve-shutter support 14 and the first component 8. The internal surface 84 is provided at an upper end of the internal cavity 81, opposite a lower axial edge 86 of the end part 80. The internal surface 84 forms an internal diameter reduction D84, smaller than the diameter D81, and converges toward the central axis X2 toward the top part of the pump 2.

The seat 142 of the valve 6 is formed by a component attached on the valve-shutter support 14. The seat 142 is an annular component attached in an internal groove 144 of the tubular part 141. The seat 142 has a frustoconical surface 142A on which the ball 12 rests.

The ball 12, and more generally the valve shutter, has a maximum external diameter D12 smaller than the minimum internal diameter D84 of the frustoconical surface 84, and therefore also smaller than the internal diameter D81. The ball 12 is therefore capable of being partially inserted into the first component 8 higher than the frustoconical surface 84, in an upper cavity 88 of the first component 8.

Since the maximum external diameter D141 of the tubular part 141 and the maximum external diameter D12 of the ball 12 are smaller than the minimum internal diameter D81 of the internal cavity 81, the seat 142 and the ball 12 can be inserted into the cavity 81 and removed from the cavity 81 from the bottom.

The nut 16 and the valve-shutter support 14 are advantageously connected so as not to be separable. They form a secured assembly facilitating disassembly and preventing successively disassembling several components. For example, the nut 16 and the valve-shutter support 14 can be glued to one another.

The valve-shutter support 14 has a collar 146, extending radially outward in the bottom part of the valve-shutter support 14, and which comes into contact with the tubular part 161 of the nut 16. The collar 146 has an axial surface 146A oriented downward. The nut 16 defines an axial surface 164 extending radially inward from the tubular part 161, and oriented upward. The surfaces 146A and 164 bear against one another, and according to one embodiment can be glued to one another.

“Inseparably connected” also means that the valve-shutter support 14 and the nut 16 can form a single integral part, that is to say, a second monobloc component 10.

The nut 16 is provided with external disassembly shapes making it possible to unscrew and disassemble the second component 10 from the first component 8.

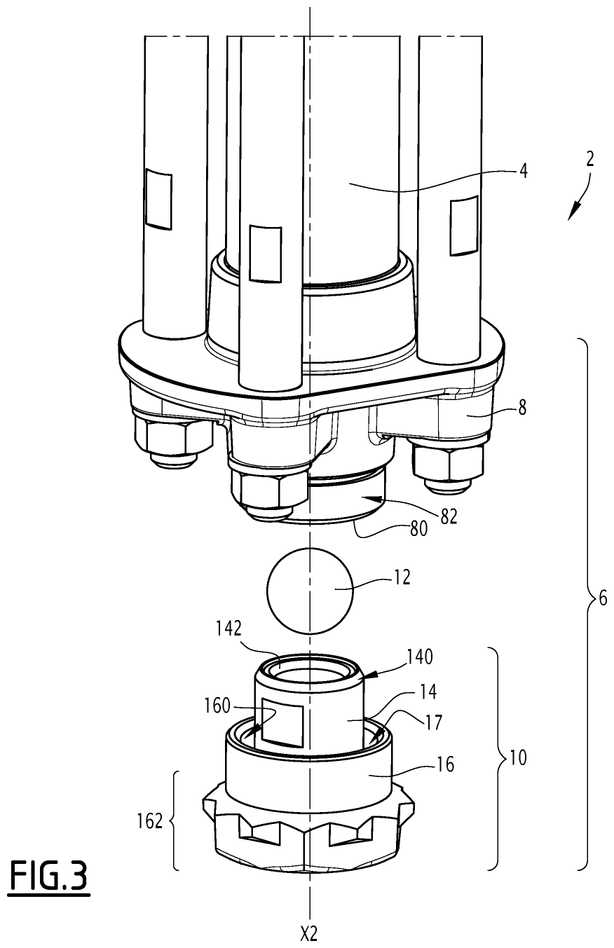

As shown in FIG. 3, the external shapes of the nut 16 can form a recess 162 for accommodating an unscrewing tool for the second component 10, such as a wrench 18.

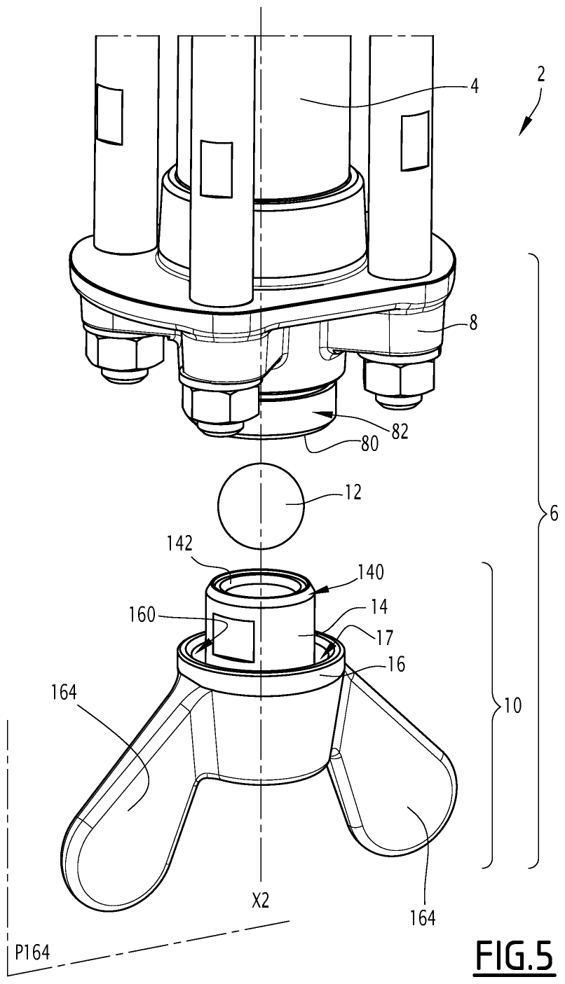

In a variant shown in FIG. 5, the external shapes of the nut 16 can form radial protuberances 164 extending for example in planes P164 comprising the central axis X2, and able to be actuated to unscrew the second component 10. For example, the nut 16 can be of the “wing nut” type, that is to say, provided with radial protuberances 164 forming radial wings allowing it to be unscrewed.

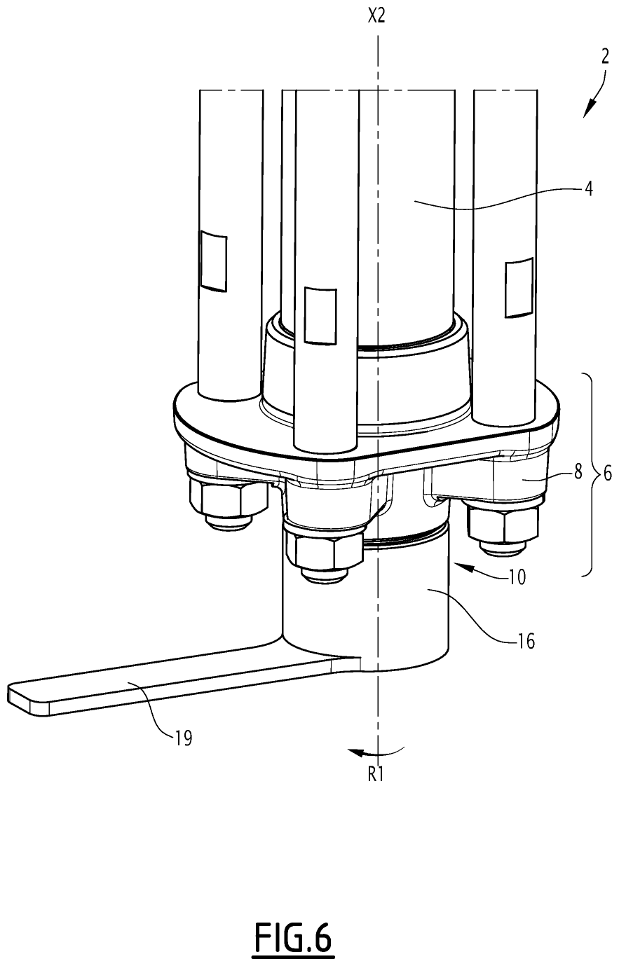

According to an aspect showed in FIG. 6, the radial protuberances can also be formed by a wrench 19 attached inseparably on the nut 16. “Attached inseparably” means that the wrench 19 or more generally the tool can be embedded, glued, or can even form a single monobloc component with the nut 16. In other words, the tool or the wrench 19 can be a material protrusion from the external periphery of the nut 16 which will serve as lever arm to actuate the loosening or tightening of the nut 16, for example respectively before and after a cleaning operation of the ball 12.

Thus, the user of the pump 2 according to the invention does not have to think to take a specific tool at the beginning of a painting session. The pump 2 therefore does not involve additional integrated equipment for maintenance directly on the usage site. In such a case, the tool or the wrench 19 forms an inseparable whole with the nut 16.

In such cases, an operator needs, in order to unscrew the nut 16, to exert a pushing action on the or one of the radial protrusions. This can for example be done by striking a radial protuberance with a standard percussive tool of the mallet or hammer type. More generally, the external shapes of the nut form one or more surfaces able to be struck with any tool in order to unscrew the second component 10.

It may also be considered for the valve-shutter support 14, the nut 16 and the unscrewing tool 18 or the wrench 19 to form an inseparable whole, which is for example glued, welded, irreversibly attached or integral so as to form a monobloc assembly.

In the case where the tool and the nut 16 do not form an inseparable whole, the external recess 162 of the nut 16 is advantageously provided with material projections chosen so as to cooperate with any type of standard tools (crescent wrench, adjustable wrench, Allen wrench, etc.) so as to make the loosening or tightening operations not be limited to the use of a specific tool.

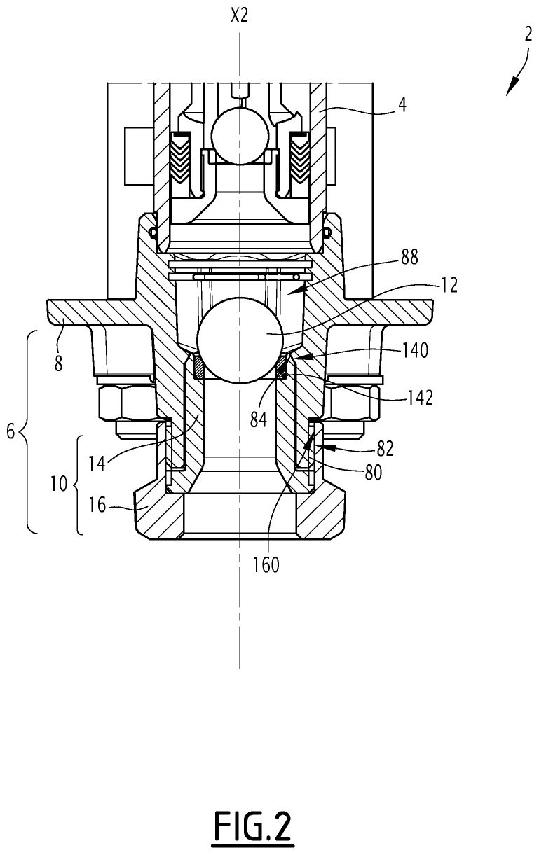

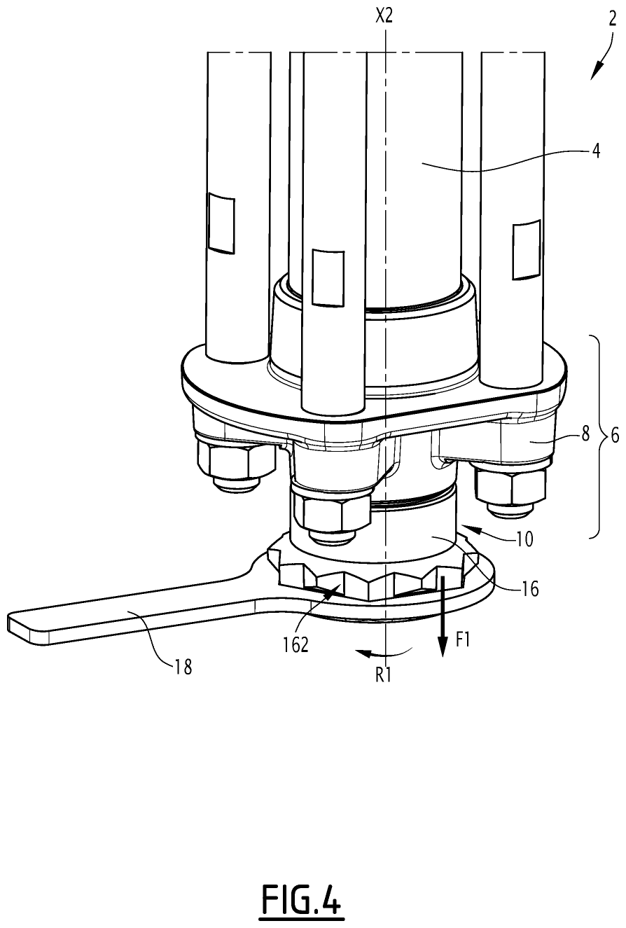

During a maintenance or cleaning operation, the valve 6 is disassembled as follows. Initially, the pump 2 and the valve 6 are assembled as shown in FIGS. 2 and 4. An operator positions the wrench 18 on the recess 162 and performs a rotation about the central axis X2 along the arrow R1 in FIG. 4, so as to unscrew the nut 16 from the first component 8. After unscrewing the nut 16 from the first component 8, the second component 10 and the ball 12 are able to be extracted from the first component 8 through the bottom, along arrow F1 in FIG. 4. This disassembly maneuver is simple and fast and does not require elaborate tooling. The first component 8 of the valve 6 does not need to be disassembled.

Further, the screw threads 160 and 82 are constantly moved away from the flow of fluid, that is to say, the circulation zone of the product. The screw thread 82 is external and is therefore fluidly insulated from the flow of fluid, formed by the internal cavity 81, by the end part 80. The internal screw thread 160 is fluidly insulated from the flow of fluid, formed by an internal duct 148 of the valve-shutter support 14, by the tubular part 141, which extends axially higher than the screw thread 160. The screw threads 160 and 82 therefore do not risk being exposed to the product and complicating the disassembly.

1. A pump for a system for applying a coating product, comprising:
a pump body; and
an intake valve secured to said pump body, connected to a source of coating product, comprising:
a valve shutter; and
a valve body, comprising:
a first component secured to said pump body; and
a second component screwed to said first component, comprising:
a valve-shutter support, situated radially toward the inside of said first component and forming a seat of the intake valve which collaborates with said valve shutter in order to establish sealing; and
a nut, attached to said valve-shutter support, extending radially around an end part of said first component, the end part having an external screw thread cooperating with an internal screw thread of the nut, and wherein, after unscrewing the nut from said first component, the second component and said valve shutter may be extracted from said first component.

2. The pump according to claim 1, wherein said nut is provided with external disassembly shapes making it possible to unscrew or screw said second component in said first component using a nonspecific tool.

3. The pump according to claim 1, wherein said valve-shutter support comprises a tubular part supporting the seat the tubular part being inserted into an internal cavity of said first component, and wherein a maximum external diameter of the tubular part of said valve-shutter support and a maximum external diameter of said valve shutter are smaller than a minimum internal diameter of the internal cavity.

4. The pump according to claim 3, wherein the external screw thread is fluidly insulated from the internal cavity by a tubular end part of said first component, and wherein the internal screw thread is fluidly insulated from an internal duct of said second component by said tubular part of said valve-shutter support.

5. The pump according to claim 1, wherein said first component comprises a frustoconical internal bearing surface against which a corresponding external frustoconical surface of said valve-shutter support bears so as to create sealing between said valve-shutter support and said first component.

6. The pump according to claim 1, wherein the seat of said intake valve is formed by a component attached on said valve-shutter support.

7. The pump according to claim 1, wherein said nut and said valve-shutter support are attached so as not to be separable.

8. The pump according to claim 1, wherein said nut is connected inseparably with a tool for unscrewing said second component.

9. The pump according to claim 1, wherein the external shapes of said nut form radial protuberances extending in planes comprising a central axis of the pump, able to be actuated by percussion by a nonspecific tool for the unscrewing or the screwing of said second component.

10. The pump according to claim 1, wherein external shapes of said nut form a recess for accommodating a nonspecific unscrewing or screwing tool for said second component.

11. Use of a pump according to claim 1, comprising using a nonspecific tool to unscrew or to screw the second component of the valve body of the intake valve of the pump with respect to the first component of the valve body of the intake valve of the pump, by action on external shapes of the nut of the second component using the nonspecific tool.
